(19) United States
(12) Patent Application Publication
(10) Pub. No.: US 2014/0122111 A1
(43) Pub. Date: May 1, 2014

(54) DISTANCE FUND RAISING

(71) Applicant: RESEARCH INSTITUTE AT NATIONWIDE CHILDREN'S HOSPITAL, Columbus, OH (US)

(72) Inventor: Donna TEACH, Bexley, OH (US)

(73) Assignee: RESEARCH INSTITUTE AT NATIONWIDE CHILDREN'S HOSPITAL, Columbus, OH (US)

(21) Appl. No.: 14/069,722

(22) Filed: Nov. 1, 2013

Related U.S. Application Data
(60) Provisional application No. 61/721,344, filed on Nov. 1, 2012.

(51) Int. Cl. G06Q 30/02; G06Q 50/22

(52) U.S. Cl. CPC G06Q 30/0279; G06Q 50/22
USPC 705/2

(57) ABSTRACT

A distance fund raising method, including using a distance or distance unit. The method can be used for calculating a donation based upon the completion of one or more distance units by a participant or a group of participants.

### RELATED APPLICATION

This application is a Non-Provisional application claiming the benefit under 35 U.S.C. 119(e) of U.S. Provisional Application No. 61/721,344, filed on Nov. 1, 2012, the content of which is hereby incorporated by reference in its entirety.

### FIELD

A method of fund raising and fund raising system, in particular distance based fund raising, for example, in the health care and hospital areas.

### BACKGROUND

There exists many fund raising events involving marathons based on miles or kilometers. However, there is a need for a more effective method and system of fund raising.

### SUMMARY

An improved method of fund raising.

An improved method of distance fund raising.

A method of distance fund raising comprising or consisting of using a distance or distance unit.

A method of distance fund raising comprising or consisting of calculating a donation using a distance or distance unit.

A method of distance fund raising comprising or consisting of using a distance or distance unit and a rate.

A method of distance fund raising comprising or consisting of calculating a donation using a distance or distance unit and a rate.

A method of distance fund raising comprising or consisting of using a standard measurement of distance, for example, inch, feet, yard, meter, fraction of mile, mile, millimeter, centimeter, decimeter, meter, fraction of kilometer, and kilometer.

A method of distance fund raising comprising calculating a donation using a standard measurement of distance, for example, inch, feet, yard, millimeter, centimeter, decimeter, meter, fraction of mile, mile, fraction of kilometer, and kilometer.

A method of distance fund raising comprising or consisting of at least one of a run event, walk event, and ride event.

A method of distance fund raising comprising or consisting of conducting at least one of a run event, walk event, and ride event.

A method of fund raising comprising or consisting of using a predetermined distance or distance unit.

A method of distance fund raising comprising or consisting of calculating a donation using a distance or distance unit.

A method of distance fund raising comprising or consisting of using a distance or distance unit and a sponsorship criterion for each distance or distance unit.

A method of distance fund raising comprising or consisting of calculating a donation using a distance or distance unit and a sponsorship criterion for each distance or distance unit.

A method of distance fund raising comprising or consisting of a distance or distance unit and a diverse or different sponsorship criterion for each distance or distance unit.

A method of distance fund raising comprising or consisting of calculating a donation using a distance or distance unit and a diverse or different sponsorship criterion for each distance or distance unit.

A method of distance fund raising comprising or consisting of using a distance or distance unit and a diverse sponsorship criterion based on personal information of different persons for each distance or distance unit.

A method of distance fund raising comprising or consisting of calculating a donation using a distance or distance unit and a diverse sponsorship criterion based on personal information of different persons for each fraction or portion of the predetermined distance.

A method of distance fund raising comprising or consisting of a distance or distance unit and a diverse sponsorship criterion based on personal health information of different persons for each distance or distance unit.

A method of distance fund raising comprising or consisting of calculating a donation using a distance or distance unit and a diverse sponsorship criterion based on personal health information of different persons for each distance or distance unit.

A method of distance fund raising comprising or consisting of using a distance or distance unit and a diverse sponsorship criterion based on patient, children, or corporate champions for each fraction or portion of the distance or distance unit.

A method of distance fund raising comprising or consisting of calculating a donation using a distance or distance unit and a diverse sponsorship criterion based on patient, children, or corporate champions for each distance or distance unit.

An improved fund raising system.

A distance fund raising system.

A distance fund raising system comprising or consisting of a website and/or mobile application.

A distance fund raising system comprising or consisting of a website and/or mobile application configured to calculate a donation using distance.

An improved distance fund raising system comprising of calculating a donation using a distance or distance unit and using a website and/or mobile application.

A distance fund raising system comprising a website and/or mobile application configured to calculate a donation using a distance or distance unit.

A distance fund raising system using a standard measurement of distance or distance unit, for example, inch, feet, yard, fraction of a mile, mile, millimeter, centimeter, decimeter, meter, fraction of kilometer, and a kilometer.

A distance fund raising system configured to calculate a donation using a standard measurement of a distance or distance unit, for example, inch, feet, yard, fraction of a mile, millimeter, centimeter, decimeter, fraction of kilometer, and a kilometer.

A distance fund raising system comprising or consisting of at least one of a run event, walk event, and ride event.

A distance fund raising system comprising or consisting of conducting at least one of a run event, walk event, and ride event over a distance or distance unit.

A distance fund raising system comprising or consisting of using a distance or distance unit.

A distance fund raising system comprising or consisting of calculating a donation using a distance or distance unit.

A distance fund raising system comprising or consisting of using a distance or distance unit and a sponsorship criterion for each distance or distance unit.

A distance fund raising system comprising or consisting of calculating a donation using a distance or distance unit and a sponsorship criterion for each distance or distance unit.

A method of distance fund raising comprising or consisting of using a distance or distance unit and a diverse or different sponsorship criterion for each distance or distance unit.

A method of distance fund raising comprising or consisting of calculating a donation using a distance or distance unit and a diverse or different sponsorship criterion for each distance or distance unit.

A distance fund raising system comprising or consisting of using a distance or distance unit and a diverse sponsorship criterion based on personal information of different persons for each distance or distance unit.

A distance fund raising system comprising or consisting of calculating a donation using a distance or distance unit and a diverse sponsorship criterion based on personal information of different persons for each fraction or portion of the distance or distance unit.

A method of distance fund raising comprising or consisting of using a distance and diverse sponsorship criterion based on personal health information of different persons for each distance or distance unit.

A method of distance fund raising comprising or consisting of calculating a donation using a distance or distance unit and a diverse sponsorship criterion based on personal health information of different persons for each distance or distance unit.

A method of fund raising comprising or consisting of using a distance or distance unit and a diverse sponsorship criterion based on patient, children, or corporate champions for each distance or distance unit.

A method of distance fund raising comprising or consisting of calculating a donation using a distance or distance unit and a diverse sponsorship criterion based on patient, children, or corporate champions for each distance or distance unit.

A method of distance fund raising for a hospital, the method comprising or consisting of conducting a distance fund raising event comprising a plurality of distance units, assigning a particular medical condition to each consecutive distance unit, and calculating a donation raised by a particular participant based on the particular number of distance units completed by the particular participant.

A method of distance fund raising for a hospital, the method comprising or consisting of conducting a distance fund raising event based on a plurality of distance units, assigning a different individual having a particular medical condition to each consecutive distance unit, and calculating a donation raised by a particular participant based on the particular number of distance units completed by the particular participant.

A method of distance fund raising for a hospital, the method comprising or consisting of conducting a distance fund raising event comprising a plurality of distance units, assigning a particular medical condition to each consecutive distance unit, and calculating a donation raised by a particular participant based on the particular number of distance units completed by the particular participant, wherein a different patient or group of patients is assigned to each particular medical condition.

A method of distance fund raising for a hospital, the method comprising or consisting of conducting a distance fund raising event comprising a plurality of distance units, assigning a particular medical condition to each consecutive distance unit, and calculating a donation raised by a particular participant based on the particular number of distance units completed by the particular participant, wherein the distance unit is a predetermined distance.

A method of distance fund raising for a hospital, the method comprising or consisting of conducting a distance fund raising event comprising a plurality of distance units, assigning a particular medical condition to each consecutive distance unit, and calculating a donation raised by a particular participant based on the particular number of distance units completed by the particular participant, wherein the distance unit is a predetermined distance, wherein the predetermined distance is one selected from the group consisting of an inch, foot, yard, fraction of mile, mile, millimeter, centimeter, decimeter, meter, fraction of kilometer, and kilometer.

A method of distance fund raising for a hospital, the method comprising or consisting of conducting a distance fund raising event comprising a plurality of distance units, assigning a particular medical condition to each consecutive distance unit, and calculating a donation raised by a particular participant based on the particular number of distance units completed by the particular participant, wherein a different medical condition is associated with each consecutive distance unit.

A method of distance fund raising for a hospital, the method comprising or consisting of conducting a distance fund raising event comprising a plurality of distance units, assigning a particular medical condition to each consecutive distance unit, and calculating a donation raised by a particular participant based on the particular number of distance units completed by the particular participant, wherein a same or similar medical condition is associated with multiple consecutive distance units.

A method of distance fund raising for a hospital, the method comprising or consisting of conducting a distance fund raising event based on a plurality of distance units, assigning a different individual having a particular medical condition to each consecutive distance unit, and calculating a donation raised by a particular participant based on the particular number of distance units completed by the particular participant, wherein the individual represents a group of persons having the same or similar medical condition.

A method of distance fund raising for a hospital, the method comprising or consisting of conducting a distance fund raising event comprising a plurality of distance units, assigning a particular medical condition to each consecutive distance unit, and calculating a donation raised by a particular participant based on the particular number of distance units completed by the particular participant, further comprising assigning a rate to each consecutive distance unit.

A method of distance fund raising for a hospital, the method comprising or consisting of conducting a distance fund raising event comprising a plurality of distance units, assigning a particular medical condition to each consecutive distance unit, and calculating a donation raised by a particular participant based on the particular number of distance units completed by the particular participant, further comprising assigning a rate to each consecutive distance unit, wherein the rate is defined by the amount of money per distance unit.

A method of distance fund raising for a hospital, the method comprising or consisting of conducting a distance fund raising event comprising a plurality of distance units, assigning a particular medical condition to each consecutive distance unit, and calculating a donation raised by a particular participant based on the particular number of distance units completed by the particular participant, further comprising assigning a rate to each consecutive distance unit, wherein the rate is fixed for all consecutive distance units.

A method of distance fund raising for a hospital, the method comprising or consisting of conducting a distance fund raising event based on a plurality of distance units, assigning a different individual having a particular medical condition to each consecutive distance unit, and calculating a donation raised by a particular participant based on the particular number of distance units completed by the particular participant.

A method of distance fund raising for a hospital, the method comprising or consisting of conducting a distance fund raising event based on a plurality of distance units, assigning a different individual having a particular medical condition to each consecutive distance unit, and calculating a donation raised by a particular participant based on the particular number of distance units completed by the particular participant, further comprising assigning a rate to each consecutive distance unit.

A method of distance fund raising for a hospital, the method comprising or consisting of conducting a distance fund raising event based on a plurality of distance units, assigning a different individual having a particular medical condition to each consecutive distance unit, and calculating a donation raised by a particular participant based on the particular number of distance units completed by the particular participant, further comprising assigning a rate to each consecutive distance unit, wherein the rate is defined by the amount of money per distance unit.

A method of distance fund raising for a hospital, the method comprising or consisting of conducting a distance fund raising event based on a plurality of distance units, assigning a different individual having a particular medical condition to each consecutive distance unit, and calculating a donation raised by a particular participant based on the particular number of distance units completed by the particular participant, further comprising assigning a rate to each consecutive distance unit, wherein the rate is defined by the amount of money per distance unit, wherein the rate is fixed for all consecutive distance units.

A method of distance fund raising for a hospital, the method comprising or consisting of conducting a distance fund raising event based on a plurality of distance units, assigning a different individual having a particular medical condition to each consecutive distance unit, and calculating a donation raised by a particular participant based on the particular number of distance units completed by the particular participant, further comprising assigning a rate to each consecutive distance unit, wherein the rate is defined by the amount of money per distance unit, wherein the rate is different for different distance units.

A method of distance fund raising for a hospital, the method comprising or consisting of conducting a distance fund raising event comprising a plurality of distance units, assigning a particular medical condition to each consecutive distance unit, and calculating a donation raised by a particular participant based on the particular number of distance units completed by the particular participant, wherein the particular medical condition is communicated as a story regarding the medical condition of a person or group of persons.

A method of distance fund raising for a hospital, the method comprising or consisting of conducting a distance fund raising event comprising a plurality of distance units, assigning a particular medical condition to each consecutive distance unit, and calculating a donation raised by a particular participant based on the particular number of distance units completed by the particular participant, wherein the particular medical condition is communicated as a story regarding the medical condition of a person or group of persons, wherein the medical condition is representative of a group of persons having a same or similar medical condition.

A computer implemented distance fund raising method for a hospital, comprising: conducting a distance fund raising event comprising a plurality of consecutive distance units; assigning a particular medical condition to each consecutive distance unit; and calculating a donation raised by a particular participant based on the particular number of distance units completed by the particular participant.

A computer implemented distance fund raising method for a hospital, comprising: conducting a distance fund raising event comprising a plurality of consecutive distance units; assigning a particular medical condition to each consecutive distance unit; and calculating a donation raised by a particular participant based on the particular number of distance units completed by the particular participant, further comprising hosting a website for accessing a fund raising system on the server.

A computer implemented distance fund raising method for a hospital, comprising: conducting a distance fund raising event comprising a plurality of consecutive distance units; assigning a particular medical condition to each consecutive distance unit; and calculating a donation raised by a particular participant based on the particular number of distance units completed by the particular participant, further comprising hosting a website for accessing a fund raising system on the server, further comprising implementing a mobile application for accessing the fund raising system with a mobile device.

A computer implemented distance fund raising method for a hospital, comprising: conducting a distance fund raising event comprising a plurality of consecutive distance units; assigning a particular medical condition to each consecutive distance unit; and calculating a donation raised by a particular participant based on the particular number of distance units completed by the particular participant, wherein the distance is a predetermined distance or distance unit.

A computer implemented distance fund raising method for a hospital, comprising: conducting a distance fund raising event comprising a plurality of consecutive distance units; assigning a particular medical condition to each consecutive distance unit; and calculating a donation raised by a particular participant based on the particular number of distance units completed by the particular participant, wherein the distance is a predetermined distance or distance unit, wherein the predetermined distance is one selected from the group consisting of an inch, foot, yard, fraction of mile, mile, millimeter, centimeter, decimeter, meter, fraction of kilometer, and kilometer.

A computer implemented distance fund raising method for a hospital, comprising: conducting a distance fund raising event comprising a plurality of consecutive distance units; assigning a particular medical condition to each consecutive distance unit; and calculating a donation raised by a particular participant based on the particular number of distance units completed by the particular participant, wherein a different patient or group of patients are assigned to each particular medical condition.

A computer implemented distance fund raising method for a hospital, comprising: conducting a distance fund raising event comprising a plurality of consecutive distance units; assigning a particular medical condition to each consecutive distance unit; and calculating a donation raised by a particular participant based on the particular number of distance units completed by the particular participant, wherein a different patient or group of patients are assigned to each particular medical condition, wherein the rate is defined by the amount of money per distance unit.

A computer implemented distance fund raising method for a hospital, comprising: conducting a distance fund raising event comprising a plurality of consecutive distance units; assigning a particular medical condition to each consecutive distance unit; and calculating a donation raised by a particular participant based on the particular number of distance units completed by the particular participant, wherein a different patient or group of patients are assigned to each particular medical condition, wherein the rate is fixed for all consecutive distance units.

A computer implemented distance fund raising method for a hospital, comprising: conducting a distance fund raising event comprising a plurality of consecutive distance units; assigning a particular medical condition to each consecutive distance unit; and calculating a donation raised by a particular participant based on the particular number of distance units completed by the particular participant, wherein a different patient or group of patients are assigned to each particular medical condition, wherein the rate is different for different distance units.

A computer implemented distance fund raising method for a hospital, comprising: conducting a distance fund raising event comprising a plurality of consecutive distance units; assigning a particular medical condition to each consecutive distance unit; and calculating a donation raised by a particular participant based on the particular number of distance units completed by the particular participant, wherein the particular medical condition is communicated as a story regarding the medical condition of a person or group of persons.

A computer implemented distance fund raising method for a hospital, comprising: conducting a distance fund raising event comprising a plurality of consecutive distance units; assigning a particular medical condition to each consecutive distance unit; and calculating a donation raised by a particular participant based on the particular number of distance units completed by the particular participant, wherein the medical condition is representative of a group of persons having a same or similar medical condition.

### BRIEF DESCRIPTION OF DRAWINGS

FIG. 1 is a diagrammatic view of the fund raising system.

### DETAILED DESCRIPTION

The method of distance fund raising can comprise or consist of using a distance or distance unit. The method of distance fund raising can comprise or consist of using a predetermined distance or distance unit. For example, the method of distance fund raising comprises or consists of calculating a donation based on or using a distance or distance unit. The step of calculating a donation can calculate the amount of the donation raise by a particular distance fund raising participate or group of participants.

The method of distance fund raising can comprise or consist of calculating a donation raised by a particular participant or group of participants based on the distance units completed. A criterion can be assigned to each particular distance unit. For example, when conducting a funding raising event for a hospital, the criterion can be a medical problem or condition, a particular patient, a particular patient having a particular medical problem or condition, a particular health provider, a particular doctor, and a particular nurse. The criterion can be different for each consecutive distance unit. Further, the criterion can be in the form of a story or background information or profile about the particular patient, health provider, doctor, or nurse.

The method of distance fund raising can comprise or consist of conducting a distance fund raising event based on or using a distance or distance unit, assigning a particular criterion to each consecutive distance unit, and calculating a donation on a participant or group of participants completing one or more distance units. Again, the criterion, for example when conducting a fund raising event for a hospital, can be a medical problem or condition, a particular patient, a particular patient having a particular medical problem or condition, a particular health provider, a particular doctor, and a particular nurse. Again, the criterion can be different for each consecutive distance unit. Further, the criterion can be in the form of a story or background information or profile about the particular patient, health provider, doctor, or nurse.

The method of distance fund raising can comprise or consist of using a rate. The method of distance fund raising can comprise or consist of using a distance or distance unit and a rate (in combination). For example, the method of distance fund raising comprises or consists of calculating a donation using a distance or distance unit and a rate. The step of calculating a donation, for example, can calculate the amount of the donation raised by a participant or participants of the distance fund raising event. For example, the distance or distance unit multiplied by the rate equals the amount of the donation. For example, the distance or distance unit multiplied by a rate based on an amount of money per distance unit times the number of distance units equals the amount of donation raised by the participant or participants.

The rate can be the same for each distance unit, or can be different for each distance unit. For example, a rate of $1 per kilometer can be fixed for all kilometers completed by a participant for a particular distance fund raising event. Alternatively, a progressive rate, for example, a rate of $1 for the first kilometer, $2 for the second kilometer, $3 for the third kilometer, and so forth, can be different for a particular participant, a group of participants, or all participants.

The method of distance fund raising, for example, can comprise a fund raising event comprising using a distance, a fraction of a distance, or a portion of the distance. The fund raising event, for example, is a run-walk-ride event. For example, the fund raising event is a twenty-six mile marathon.

For example, each mile of the twenty-six (26) mile marathon is based on a criterion. The criterion can be different for each mile. For example, each mile can be based on a different person (e.g. child patient), in particular a story concerning the health condition of the particular person. The particular person can be representative of a group of persons meeting the particular criterion (e.g. same or similar health condition/issue).

The persons can be nominated using a website, social media (e.g. Face Book, Twitter), news release, or other method, for example, representative of the community of the fund raising event. The method can provide sponsorship packages and stories regarding the nominated person or persons.

### Distance Fund Raising System

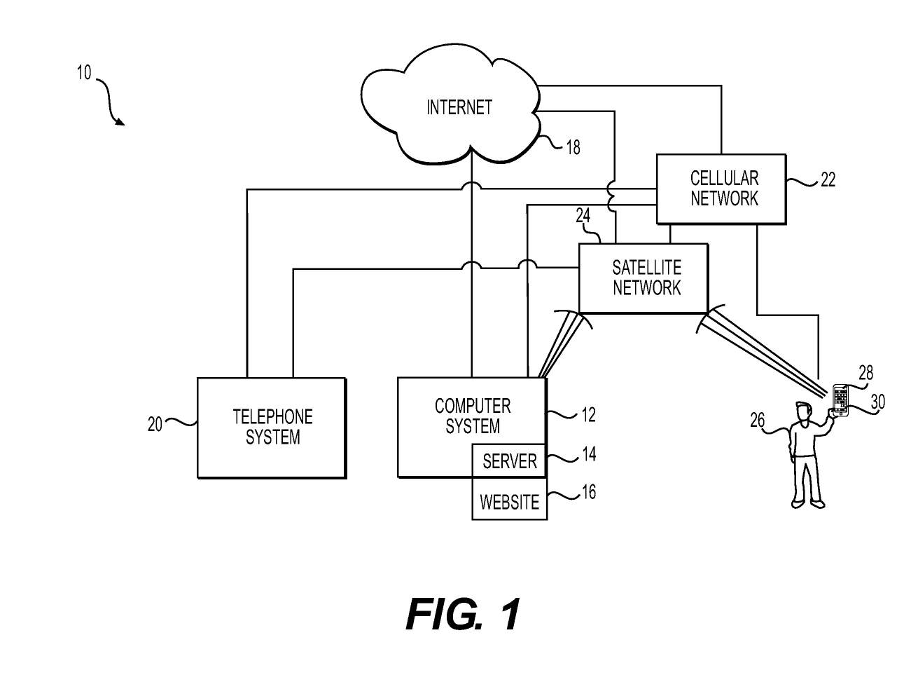

An example of a distance fund raising system 10 is shown in FIG. 1. The distance fund raising system 10 comprises a computer system 12 comprising a server 14 and hosting a website 16. The computer system 12 is connected to the Internet 18, telephone system 20, cellular network 22, and satellite network 24. A user 26 using a mobile device 28 loaded with a mobile application 30 can access the website 16 via the Internet 18, telephone system 20, and/or cellular network 22.

The distance fund raising system 10 allows users to nominate person's from their community independently, or from a list of possible nominees provided on the website 14. The nominees selected, for example, based on the greatest number of hits on the website are assigned to particular miles of the marathon by the administer of the distance fund raising system 10.

### Example #1

The method of fund raising comprises a fund raising event comprising a distance unit of one mile. For example, the fund raising event is a twenty-six (26) mile marathon based on twenty-six (26) patients. A different patient of the twenty-six (26) patients is designated for each consecutive mile of the twenty-six miles. The twenty-six patients have twenty-six different health conditions, and are representative of a large group of one-million patient's being medically treated by the hospital in a given year. The patient's health condition of each patient is represented by a different story for each patient.

For example, the 26 mile marathon includes an additional 0.2 mile at the end of the marathon.

For example, the different health conditions or criterion for the patients at a particular mile is the following:

| | |
|---|---|
| MILE 1 | LAUNCH MILE (e.g. starting line Ambassador) |
| MILE 2 | CANCER |
| MILE 3 | REHAB/TRAMA |
| MILE 4 | NICU |
| MILE 5 | DIABETES (TYPE 1) |
| MILE 6 | CANCER (RESEARCH) |
| MILE 7 | ADVOCAY |
| MILE 8 | HEART (TRANSPLANT) |
| MILE 9 | NEUROSCIENCE/MD |
| MILE 10 | CANCER |
| MILE 11 | NICU |
| MILE 12 | FREQUENT FLYER (G1) |
| MILE 13 | JR. PHILANTHROPIST |
| MILE 14 | CF |
| MILE 15 | CANCER (BRAIN TUMOR - NEURO) |
| MILE 16 | NICU |
| MILE 17 | REHAB/TRAUMA/ED |
| MILE 18 | DIABETES |
| MILE 19 | CHILD LIFE - FREQUENT FLYER |
| MILE 20 | HEART (RESEARCH) |
| MILE 21 | ADVOCACY |
| MILE 22 | PLASTICS |
| MILE 23 | REHAB |
| MILE 24 | HEART |
| MILE 25 | CANCER |
| MILE 26 | NATIONWIDE MILE - NW ASSOCIATE |
| MILE 27 | 0.2 MILES, CHILDREN'S “RALLY ALLEY” - |
| | DEDICATED TO EVERY CHILD |

The rate is $1 per mile completed by each participant. Thus, each participant raises $1 per mile completed for each person or business sponsor of the particular participant.

### Example #2

The same as Example #1; however, a progressive rate of $1 for the first mile, $2 for the second mile, $3 for the third mile, and so on, replaces the fixed rate of $1 per mile.

### Example #3

The method of fund raising comprises a fund raising event comprising a distance unit of one kilometer. For example, the fund raising event is a 5K marathon based on five (5) doctors and/or nurses being honored at the fund raising event. A different doctor or nurse of the five (5) doctors and/or nurses is designated for each consecutive kilometer of the five (5) kilometers. For example, five (5) doctors are selected in different specialty areas, which are representative of a large group of patient's being medically treated by the hospital in a given year in that particular specialty area. The doctor's background or practice is represented by a different story for each doctor.

For example, the different specialty area for each doctor is the following:

| | |
|---|---|
| KILOMETER 1 | LAUNCH KILOMETER (e.g. starting |
| | line Ambassador) |
| KILOMETER 2 | CANCER (DOCTOR #1) |
| KILOMETER 3 | HEART (DOCTOR #2) |
| KILOMETER 4 | REHAB/TRAMA (DOCTOR #3) |
| KILOMETER 5 | DIABETES (DOCTOR #4) |

### DRAWINGS

10—fund raising system
12—computer system
14—server
16—website
18—Internet
20—telephone system
22—cellular network
24—satellite network
26—user
28—mobile device
30—mobile application

We claim:

1. A method of distance fund raising for a hospital, the method comprising:
conducting a distance fund raising event comprising a plurality of distance units;
assigning a particular medical condition to each consecutive distance unit; and
calculating a donation raised by a particular participant based on the particular number of distance units completed by the particular participant.

2. A method of distance fund raising for a hospital, the method comprising:
conducting a distance fund raising event based on a plurality of distance units;
assigning a different individual having a particular medical condition to each consecutive distance unit; and
calculating a donation raised by a particular participant based on the particular number of distance units completed by the particular participant.

3. The method according to claim 1, wherein a different patient or group of patients is assigned to each particular medical condition.

4. The method according to claim 1, wherein the distance unit is a predetermined distance.

5. The method according to claim 4, wherein the predetermined distance is one selected from the group consisting of an inch, foot, yard, fraction of mile, mile, millimeter, centimeter, decimeter, meter, fraction of kilometer, and kilometer.

6. The method according to claim 1, wherein a different medical condition is associated with each consecutive distance unit.

7. The method according to claim 1, wherein a same or similar medical condition is associated with multiple consecutive distance units.

8. The method according to claim 2, wherein the individual represents a group of persons having the same or similar medical condition.

9. The method according to claim 1, further comprising assigning a rate to each consecutive distance unit.

10. The method according to claim 9, wherein the rate is defined by the amount of money per distance unit.

11. The method according to claim 9, wherein the rate is fixed for all consecutive distance units.

12. The method according to claim 9, wherein the rate is different for different consecutive distance units.

13. The method according to claim 2, further comprising assigning a rate to each consecutive distance unit.

14. The method according to claim 13, wherein the rate is defined by the amount of money per distance unit.

15. The method according to claim 13, wherein the rate is fixed for all consecutive distance units.

16. The method according to claim 13, wherein the rate is different for different distance units.

17. The method of claim 1, wherein the particular medical condition is communicated as a story regarding the medical condition of a person or group of persons.

18. The method of claim 17, wherein the medical condition is representative of a group of persons having a same or similar medical condition.

19. A computer implemented distance fund raising method for a hospital, comprising: conducting a distance fund raising event comprising a plurality of consecutive distance units; assigning a particular medical condition to each consecutive distance unit; and calculating a donation raised by a particular participant based on the particular number of distance units completed by the particular participant.

20. The method according to claim 19, further comprising hosting a website for accessing a fund raising system on the server.

21. The method according to claim 20, further comprising implementing a mobile application for accessing the fund raising system with a mobile device.

22. The method according to claim 19, wherein the distance is a predetermined distance.

23. The method according to claim 22, wherein the predetermined distance is one selected from the group consisting of an inch, foot, yard, fraction of mile, mile, millimeter, centimeter, decimeter, meter, fraction of kilometer, and kilometer.

24. The method according to claim 19, wherein a different patient or group of patients are assigned to each particular medical condition.

25. The method according to claim 29, further comprising assigning a rate to each consecutive distance unit.

26. The method according to claim 25, wherein the rate is defined by the amount of money per distance unit.

27. The method according to claim 25, wherein the rate is fixed for all consecutive distance units.

28. The method according to claim 25, wherein the rate is different for different distance units.

29. The method of claim 19, wherein the particular medical condition is communicated as a story regarding the medical condition of a person or group of persons.

30. The method of claim 19, wherein the medical condition is representative of a group of persons having a same or similar medical condition.
